(19) United States
(12) Patent Application Publication
(10) Pub. No.: US 2013/0262056 A1
(43) Pub. Date: Oct. 3, 2013

(54) GRID REPRESENTATION OF DOMAIN MODELS

(71) Applicant: LITMUS BLUE, LLC, Broomfield, CO (US)

(72) Inventors: Duane Ray Webber, Broomfield, CO (US); Vitalii Stakhov, Zhitomir (UA); Thomas Damon DeGerlia, Lakewood, CO (US)

(73) Assignee: LITMUS BLUE, LLC, Broomfield, CO (US)

(21) Appl. No.: 13/843,861

(22) Filed: Mar. 15, 2013

Related U.S. Application Data
(60) Provisional application No. 61/618,617, filed on Mar. 30, 2012.
(60) Provisional application No. 61/618,623, filed on Mar. 30, 2012.

(51) Int. Cl. G06F 17/50

(52) U.S. Cl. CPC G06F 17/5009
USPC 703/2

(57) ABSTRACT

A configurable application includes a domain model having one or more model entities. Configurable grids define a grid having cells that can be bound, based on states, to one or more model entities, or to one or more model entity attributes. Grids provide representations of model entities. A grid can be represented by a collapsed representation that preserves row and column header information.

### CROSS-REFERENCE TO RELATED APPLICATIONS

The present application claims priority to each of the following provisional applications, each of which is hereby explicitly incorporated herein, in its entirety, by reference: U.S. Provisional Application No. 61/618,617, entitled “CONFIGURABLE GRID REPRESENTATION OF DOMAIN MODELS,” filed on Mar. 30, 2012; and U.S. Provisional Application No. 61/618,623, entitled “COLLAPSIBLE GRID REPRESENTATION OF DOMAIN MODELS,” filed on Mar. 30, 2012.

### SUMMARY

Embodiments of the invention enable the creation of multiple grid representations of at least a portion of a domain model and/or model entities. A domain refers to a subject area to which an application is applied. A domain model refers to a system of abstractions representing aspects of a domain. According to embodiments, domain models and, for example, their collapsible grid representations can be constructed using any number of various types of programming paradigms such as, for example, object-oriented programming, functional programming, process-oriented programming, multi-paradigm programming, aspect-oriented programming, and the like.

Embodiments of input representation aspects include configurable grid definitions, which provide views of an entity or a set of entities from an underlying domain model. Grid definitions may be used to instantiate real grids in an application when the domain view is to be part of the input. Embodiments allow a grid to be defined outside of a run-time environment and be able to be used at run-time. A grid can include a set of cells that can be organized in any number of dimensions. For example, in embodiments, a grid can be a two-dimensional set of cells organized in rows and columns, a three-dimensional set of cells organized as a cube, a four-dimensional set of cells organized as a hypercube, and the like. In embodiments, cells may also define drilldown views (e.g., “sub-views”), which can include grids, forms, or other custom input views that can be enabled for a specific cell. In embodiments, drilldown views can simplify a representation by embedding a representation inside of a grid.

In embodiments, a cell may have one or more associated states that may define any number of behaviors including, but not limited to, i) whether the cell may contain a linkable component, ii) allowed display values from a collection of values, iii) whether the cell is active or inactive, (iv) whether the cell is read-only or read/write, v) whether the cell may be “drilled” into to display a sub-view, and/or vi) validation criteria for the cell. In embodiments, a configurable grid may allow each cell, and its state, to be individually defined, and in embodiments, groupings (e.g., rows and columns, cubes, hypercubes, and the like) of cells may be associated with a state. Additionally, in embodiments, an activation of a cell state may be triggered by one or more rules (referred to herein as “active criterion” or, in the plural, as “active criteria”).

In embodiments, a cell may contain a number of states which can allow the cell to be bound to multiple domain attributes or domain entities with one state active at a time. In embodiments, a cell state may also customize available values, which may be chosen from an underlying collection of values. Embodiments of the invention allow linking strings, numeric values, model entities, or model entity attributes. In embodiments, link types can be restricted so that, for example, an inadvertent link is not created in the model at run-time. In embodiments, a cell state can be read-only or read/write. Read-only cells can be useful to indicate that a cell cannot be used as to accept input under the current model state, but may be used if the model is in a different state. In embodiments, read-only cells can also be used to present non-input information (e.g., output information, state information, status information, descriptive information, and the like).

In embodiments, a domain model includes one or more model entities, which may include attributes such as, for example, properties, values, arrays, data, enumerations, methods, algorithms, events, and the like. Aspects of a domain model are represented using collapsible grids, which may be presented, for example, via a graphical user interface (GUI). According to embodiments, model entities and definitions of collapsible grids can include objects, aspects, processes, and the like. In embodiments, a grid can represent aspects of a domain model and the grid may be represented by a collapsed representation of the grid, which preserves row and column header information. Additionally, a cell may be validated via validation rules. In embodiments of the invention, validation rules can be defined directly in the grid definition or tied to a set of defined business rules in code, and may affect the appearance of the grid.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 depicts an illustrative conception of a configurable domain environment in accordance with embodiments of the invention;

FIG. 2 is a schematic block diagram depicting aspects of input representation in accordance with embodiments of the invention;

FIGS. 3A and 3B depict illustrative binding aspects associated with state definitions in accordance with embodiments of the invention;

FIGS. 4A and 4B illustrate examples of collapsing grids in accordance with embodiments of the invention; and

FIG. 5 is a flow diagram depicting an illustrative method for creating a configurable grid representation of a model entity or model entities in accordance with embodiments of the invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the present disclosure.

### DETAILED DESCRIPTION

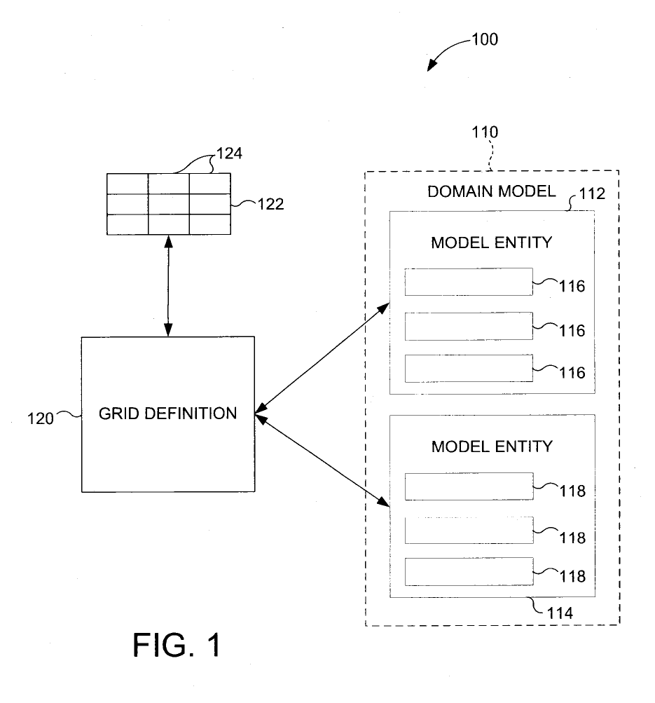

FIG. 1 depicts an illustrative conception of a configurable domain environment 100 (referred to herein, interchangeably, as an “application”). In embodiments, the environment 100 can be, for example, packaged as an application or service, as part of an application or service, or the like. The illustrative domain environment 100 shown in FIG. 1 is not intended to suggest any limitation as to the scope of use or functionality of embodiments of the inventions disclosed throughout this document. Neither should the illustrative domain environment 100 be interpreted as having any dependency or requirement related to any single component or combination of components illustrated therein. Additionally, any one or more of the components depicted in FIG. 1 can be, in embodiments, integrated with various ones of the other components depicted therein (or components not illustrated). Any number of other components or combinations of components can be integrated with the illustrative domain environment 100 depicted in FIG. 1, all of which are considered to be within the scope of the invention.

As illustrated, the environment 100 includes a domain model 110 that includes one or more model entities 112 and 114. Model entities 112 and 114 can include any type of entities that can be used in the context of domain modeling and may include code written in a coding language such as, for example, C, C++, C#, Java, Ruby, or the like. Model entities 112 and 114 can include entity attributes 116 and 118. Examples of entity attributes include aspects of state (e.g., attributes, variables, definitions, properties), behavior (e.g., methods, functions, algorithms, relations, events, event-handlers), and the like. Each of the model entities 112 and 114 can include any number of entity attributes 116 and 118, respectively. In embodiments, one or more model entities 112 and 114 are combined to create the domain model 110. According to embodiments, the domain model 110 can be used to model any number of different types of domain-based problems and perform any number of different types of domain-based tasks. Examples of such tasks include financial modeling, investment decision modeling, engineering modeling, performing numerical approximation to complex systems of equations, and the like.

To facilitate a clear illustration of various aspects of embodiments of the invention, a simple modeling problem involving the configuration of fruit baskets will be discussed throughout this disclosure. For example, a domain environment in accordance with embodiments of the invention may be used to configure a “fruit basket” domain model consisting of a fruit basket model entity and different fruit model entities (e.g. an apple model entity, an orange model entity, and a banana model entity), which may have various arbitrary attributes (e.g., properties, methods, relations, events, functions, methods, conditions, and the like) related to color, size, placement, or types of fruit to be included, relationships and/or interactions between model entities, and the like.

The environment 100 also includes a definition 120 of a grid 122, which can include any number of grid cells 124. In embodiments, the environment 100 can include a number of different grid definitions 120. In embodiments, a grid 122 may be organized having particular conceptualizations (referred to herein as “representation properties”) represented by one or more rows of a grid 122, while various attributes of the representation properties can be described by columns of the grid 122. It should be understood that the description of representation properties and columns is merely one example of any number of possible types of organizations of representations. Examples of other types of representation organizations can include, but are not limited to, cubes, hypercubes, graphs, and the like. In embodiments, grid definitions can define states, rules, links, bindings, and the like. Additionally, in embodiments, the grid 122 may be a collapsed representation of one or more other grids.

In embodiments, grid definitions (and, in embodiments, any number of other definitions or attributes included in representation entities) can define states, active criteria, links, bindings, validation criteria (which can be used to test the validity of various cells, links, bindings, and the like, without having to feed test data into the domain model), defaults (e.g., default cell values, default bindings, default links, and the like), and the like. Any number of different types of states can be defined on (e.g., corresponding to) a cell. In embodiments, each cell, and its state, can be individually defined, and in embodiments, groupings (e.g., rows and columns, cubes, hypercubes, and the like) of cells may be defined in one or more states. A state can, for example, define a behavioral attribute. Such behavioral attributes can include, for example, whether a cell (or group of cells) is active or inactive, a set of allowed display values associated with a bound value set, whether a cell (or group of cells) is read-only or read/write, whether a cell (or group of cells) is linkable, one or more validation criterion associated with a cell (or group of cells), whether a binding, link, and/or drilldown is active or inactive, and the like. In this manner, states can be used to provide dynamic functionality based on events, model entity states, domain model states, and the like. States, cells, groups of cells, bindings, links, drilldowns, and the like, can be activated and deactivated according to active criteria.

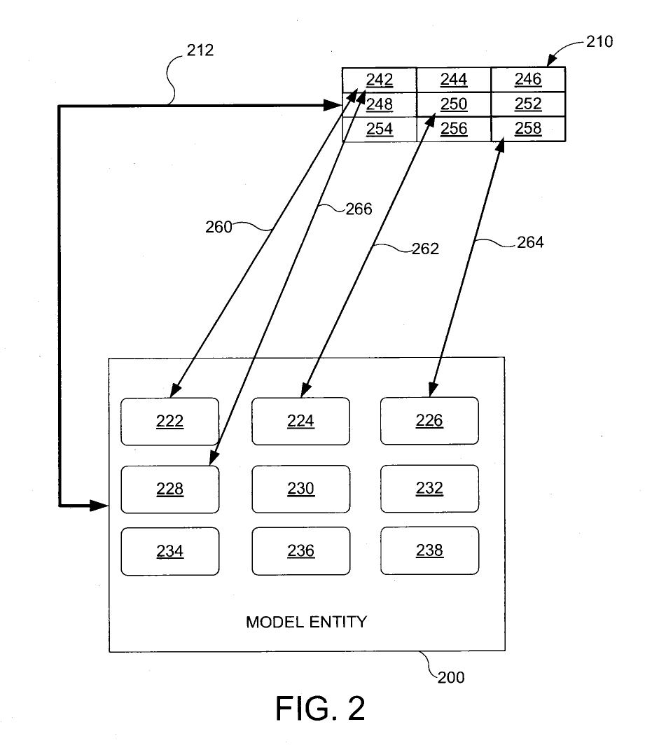

FIG. 2 is a schematic block diagram depicting aspects of input representation in accordance with embodiments of the invention. As shown, a model entity 200 can include a number of different model entity attributes 222, 224, 226, 228, 230, 232, 234, 236, and 238. A grid binding 212 can be defined between a grid 210 and the model entity 200. In embodiments, the grid binding 212 can be active or inactive based on a state which may be determined based on one or more active criteria. In some embodiments, a grid 210 can be directly bound (e.g., via grid binding 212) to a model entity 200 while, in other embodiments, the grid binding 212 can be indirect. For example, in embodiments, the grid binding 212 can bind the grid 210 to an intermediary construct (e.g., a transfer object or entity, a translation component, a network service component, a deduplication component, and the like), which can be bound to, or in effect, alter the state of, the model entity 200. According to embodiments, whether the grid binding 212 is direct or indirect, the grid binding 212 can allow for changes applied at the representation level (e.g., via the grid 210) to affect one or more states of the model entity 200.

Additionally, one or more cell bindings can be defined. In embodiments, a cell binding can bind a grid cell to a model entity or model entity attribute. As depicted in FIG. 2, a first cell binding 260 binds a cell 242 to an entity attribute 222, a second cell binding 262 binds a cell 250 to an entity attribute 224, and a third cell binding 264 binds a cell 258 to an entity attribute 226. It should be understood that, in the context of embodiments of the invention, a binding can be created between a representation (e.g., a grid cell) and one (e.g., via a single state definition) or more (e.g., via multiple state definitions) model entities or model entity attributes. Additionally, in embodiments, cell bindings may bind a grid cell to more than one model entity or model entity attribute. For example, FIG. 2 depicts a cell binding 266 that binds the cell 242 to an entity attribute 228, which may be in addition to the binding 260 that binds the cell 242 to the entity attribute 222.

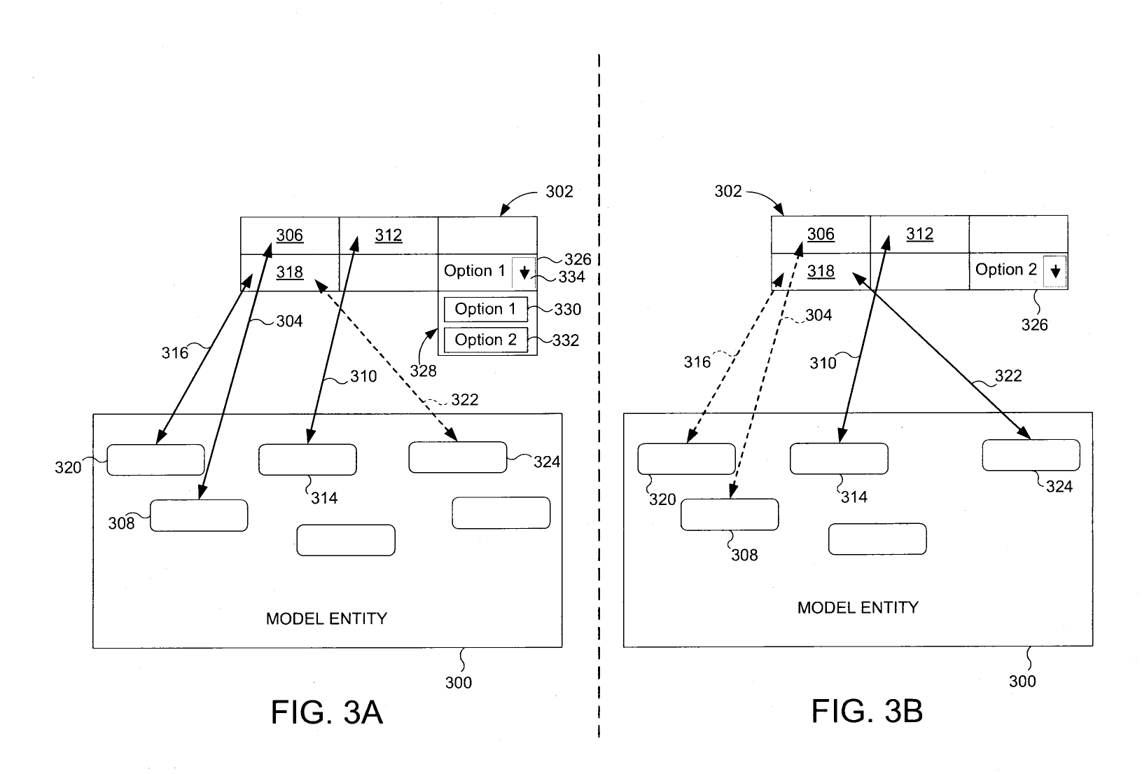

FIGS. 3A and 3B depict illustrative binding aspects associated with state definitions in accordance with embodiments of the invention. In FIGS. 3A and 3B, a model entity 300 is represented by a grid 302. As illustrated, a cell binding 304 binds a cell 306 to a model entity attribute 308. A cell binding 310 binds a cell 312 to a model entity attribute 314. A cell binding 316 binds a cell 318 to a model entity attribute 320 and an additional cell binding 322 binds the cell 318 to another model entity attribute 324. A cell 326 includes an enumeration 328 of a number of options 330 and 332, which may, for example, correspond to different domain tasks facilitated by the model entity 300. In embodiments, a button 334 can be provided that, when selected, causes the enumeration 328 to be displayed, allowing selection of the model 330 or 332. In some embodiments, the grid 302 might not include an enumeration 328.

In FIG. 3A, “Option 1” has been selected. As a result of the “Option 1” being selected, one or more active criteria corresponding to the cell 318 causes one or more states to be activated or deactivated based on the selection. For example, in FIG. 3A, as a result of selection of “Option 1”, an active criterion corresponding to the cell 318 causes the binding 316 to be active and another active criterion (or, in embodiments, the same active criterion) causes the binding 322 to be inactive. In FIG. 3B, “Option 2” has been selected and, as a result, the active criteria causes binding 316 to be inactive and binding 322 to be active. Whether bindings 316 and 322 are active may be determined, in embodiments, according to an active criterion that is triggered by something other than selection of a member of an enumeration 328 (e.g., a model entity or domain model being in a particular state, an event, and the like).

For instance, in the fruit basket example, the model entity 300 might be an “apple” entity and a property of the apple represented by the grid 302 might be the sweetness of the apple. The state, for example, may correspond to the units (e.g., variables) upon which a determination of the sweetness is based. Thus, for example, a first state may correspond to an expression of sweetness as a function of sunlight exposure (e.g., relating to the effect that exposure to sunlight has upon the sweetness) and a second state might correspond to an expression of sweetness as a function of humidity exposure (e.g., relating to the effect that exposure to humidity has upon the sweetness).

In embodiments, a collapsed representation of a grid may be defined. For example, using a collapsed representation, a set of rows and columns can be represented in a single row, while preserving row and column identifiers in column headers associated with the columns. In this manner, the representation (e.g., grid) can be collapsed without losing information used to completely identify a specific cell using the same nomenclature that would be used to identify the same cell in a non-collapsed representation. In embodiments, nomenclature consistency may be useful for functional aspects of domain models such as identifying a link or a path to a cell. Collapsed representations can be used, in embodiments, to represent multiple model entities, composite model entities, and the like in the same grid.

According to embodiments, collapsed representations can also be used to provide filter views, which can include a set (which may include all or a subset) of related model entities, or of related model entities of a particular representation entity type or types, and which can allow for creation or editing of numerous model entities, or numerous model entities of a representation entity type or types, in a single view. For example, an apple filter view may be selected from a fruit basket entity, causing a collapsed representation of attributes related to all of the available apple types, or specific apple types. In embodiments, filter views can correspond to model entities, representation entities, and the like.

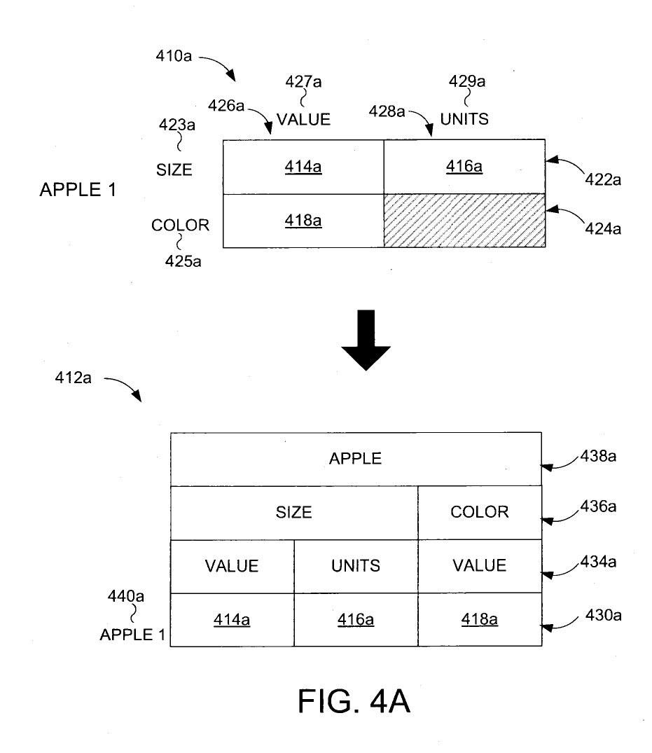

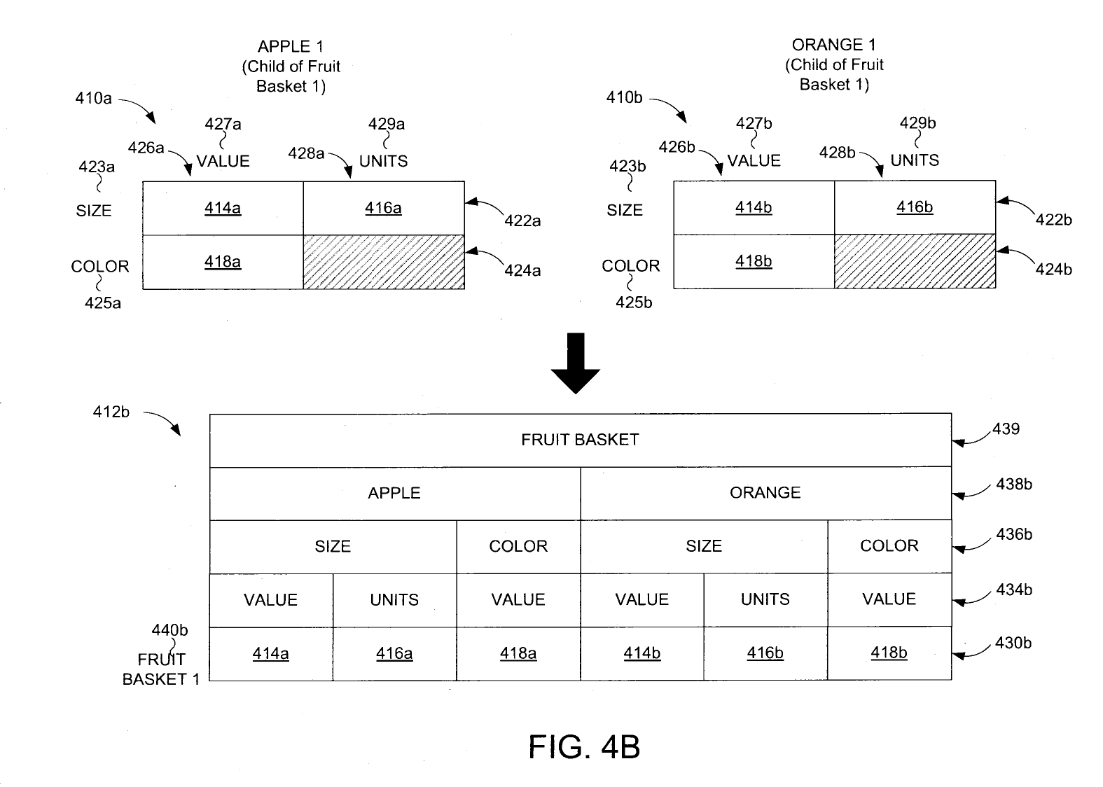

FIGS. 4A and 4B illustrate examples of collapsing grids in accordance with embodiments of the invention. For instance, in the fruit basket example, grid 410a may be used to provide inputs to an apple model entity (“Apple 1”) and may include a representation property 422a related to the size of the apple, identified by a row header 423a; a representation property 424a related to a color of the apple, identified by a row header 425a; a value column 426a (e.g., magnitude of some measurement of size, indication of color, and/or the like), identified by a column header 427a; and a units column 428a (e.g., units in which the magnitude is expressed such as cubic centimeters, cubic inches, and the like), also identified by a column header 428a. Because color, in this example, may be expressed with a single, independent word or phrase, the units column 428a may not be active for the color property 424a. However, in other embodiments, color may be expressed in other ways (e.g., related to pixel counts or densities, intensities, saturations, and/or the like) and may include a units column.

Thus, the grid 410a may include input cells 414a, 416a, and 418a. A grid 412a can be defined to collapse the representation of grid 410a without losing information (e.g., information represented in the cells, the column headers, and the like). As shown, the grid 412a includes one row 430a of input cells 414a, 416a, and 418a. Additionally, the grid 412a preserves the column headers 427a and 429a in a header row 434a and the row headers 423a and 425a in a higher-level header row 436a. Additionally, the grid 412a can include a higher-level header row 438a that includes a header identifying the associated model entity and may, in embodiments, include a row header 440a identifying the associated model entity as represented by a particular representation entity.

Similarly, as shown in FIG. 4B, grid 410b may be used, for example, to provide inputs to an orange model entity (e.g., as represented by an “Orange 1” representation entity) and may include a representation property 422b related to the size of the orange, identified by a row header 423b; a representation property 424b related to a color of the orange, identified by a row header 425b; a value column 426b (e.g., magnitude of some measurement of size, indication of color, and/or the like), identified by a column header 427b; and a units column 428b (e.g., units in which the magnitude is expressed such as cubic centimeters, cubic inches, or the like), also identified by a column header 429b.

A grid 412b can be defined to collapse the representation of grids 410a and 410b without losing information, in which, for example, the apple and orange representation entities may be related or allowed related entities of fruit basket model entities. In embodiments, the apple and orange representations may be included within one or more fruit basket model entities. As shown, the grid 412b includes one row 430b of input cells 414a, 416a, 418a, 414b, 416b, and 418b and preserves the column headers 427a, 427b, 429a, and 429b in a header row 434b. The grid 412b also preserves the row headers 423a, 425a, 423b, and 425b in a higher-level header row 436b. In the illustrated example, the row 430b is identified by a row header 440b that identifies that the row corresponds to a “Fruit Basket 1” model entity. In this manner, a grid 412b can, for example, be used to show collapsed representations of attributes associated with a number of model entities, where each row may correspond to a model entity that may be a parent of, contain, or otherwise be related to, the other model entities represented in the row. For example, similar features of a second fruit basket model entity could be represented in a second row, which may be labeled “Fruit Basket 2.”

By preserving the header and cell information when forming a grid 412a or 412b, embodiments of the invention allow the representation to be consistent between both grid representations 410a/410b and 412a/412b. Additionally, by retaining each cell representation, embodiments of the invention allow preservation of information such as, for example, identifications of links or paths. For example, cell 414a of the grid 410a can be represented by the same path name, e.g., “[Apple1]$Size$Value”, as cell 414a of the grid 412b. Note, however, that, in embodiments, a grid 410a can be associated with a particular model entity type (e.g., [Apple1]) and, therefore, it may be sufficient for the cell 414a in the grid 410a to be represented by “$Size$Value” within grid 410a, whereas, in the grid 412b, it may be useful for the cell 414a to include “[Apple1]” as part of its path in grid 412b, to indicate the model entity to which the cell relates. The use of relative path names described above simplifies the path based on where the cell is referenced and does not affect the preservation of information; the full path name may still be used to identify the cell and will be consistent between the collapsed and non-collapsed grid representations.

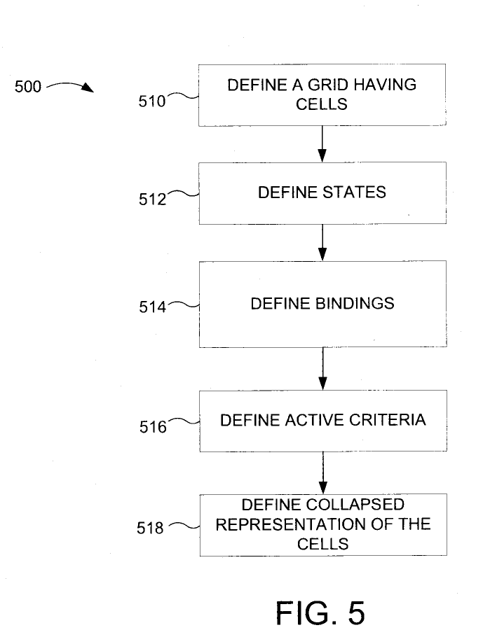

FIG. 5 is a flow diagram depicting an illustrative method 500 for creating a configurable grid representation of a model entity or model entities in accordance with embodiments of the invention. The illustrative method 500 is just one example of a method that could be performed in accordance with embodiments of the invention and is not intended to imply any particular order among or between various steps herein disclosed (or other steps that may be employed that are not explicitly disclosed in the context of FIG. 5). For instance, in embodiments, additional states may be added after active criteria are added; representational aspects of a cell, such as link and drilldown view definitions may be defined before active criteria are defined; and the like. In embodiments, the domain model and representation (or representations) can be combined to create an application. In embodiments, an application can include application components such as, for example, model entities, model entity attributes, and the like. The representation of the domain model can include, for example, one or more configurable grid representation. In embodiments, the domain model includes one or more model entities, each of which can include one or more model entity attributes such as, for example, model entity members, properties, methods, events, and the like.

As shown at block 510, the illustrative method 500 includes defining a grid. Defining the grid can include defining cells, defining rows of cells, defining columns of cells, defining higher-order dimensional arrangements of cells, and defining a visual layout of a grid having one or more cells. In embodiments, for example, defining the visual layout can include defining a set of cells each identified by a row and a column. At block 512, the illustrative method 500 includes defining one or more states corresponding to a cell. In embodiments, states can also correspond to any number of other application components, as described above. Embodiments of the illustrative method 500 also include defining one or more bindings (block 514). Each binding can bind a cell to a model entity or model entity attribute. Additionally, in embodiments, a binding (and associated states) can be defined such that the binding is active when a particular state is active.

As shown at block 516, the illustrative method 500 includes defining active criteria associated with states. For example, in embodiments, a state corresponding to a cell may define a behavioral attribute that includes at least one of whether the cell is active or inactive, a set of allowed display values associated with a bound value set, whether the cell is read only or read/write, whether the cell is linkable, and validation criteria associated with the cell. In embodiments, an active criterion can be defined that determines the behavioral attribute. Embodiments of the illustrative method 500 also include defining a collapsed representation of the set of cells (block 518), where the collapsed representation preserves row and column identifiers for each cell in column headers.

Embodiments of the disclosed subject matter are described in the general context of computer-executable instructions. Computer-executable instructions can include, for example, computer code, machine-useable instructions, and the like such as, for example, program components, capable of being executed by one or more processors associated with a computing device. Generally, program components including routines, programs, model entities, objects, modules, data structures, and the like, refer to code that, when executed, causes a computing device to perform particular tasks (e.g., methods, calculations, and the like) or implement or manipulate various abstract data types. Some or all of the functionality contemplated herein can also be implemented in hardware and/or firmware.

Computer-readable media include both volatile and non-volatile media, removable and nonremovable media, and contemplate media readable by a database, a processor, a router, and various other networked devices. By way of example, and not limitation, computer-readable media can include computer-storage media, which is media implemented in any method or technology for storing information. Examples of stored information include computer-executable instructions, data structures, program modules, and other data representations. Media examples include, but are not limited to, Random Access Memory (RAM); Read Only Memory (ROM); Electronically Erasable Programmable Read Only Memory (EEPROM); flash memory or other memory technologies; Compact Disc Read-Only Memory (CD-ROM), digital versatile disks (DVDs) or other optical or holographic media; magnetic cassettes, magnetic tape, magnetic disk storage or other magnetic storage devices; data transmissions; or any other medium that can be used to encode information and can be accessed by a computing device such as, for example, quantum state memory, and the like.

Embodiments may be practiced in a variety of system configurations, including handheld devices, general-purpose computers, specialty computing devices, servers, workstations, cloud computing environments, and the like. Embodiments may also be practiced in distributed computing environments where tasks are performed by a number of computing devices that are linked through a communications network. According to embodiments, a computing device can include any type of computing device suitable for implementing embodiments of the invention. Examples of computing devices include “workstations,” “servers,” “laptops,” “desktops,” “tablet computers,” “hand-held devices,” and the like, all of which are contemplated within the scope of FIG. 1 and reference to various components of the domain environment 100.

In embodiments, a computing device includes a bus that, directly and/or indirectly, couples the following devices: a processor, a memory, an input/output (I/O) port, an I/O component, and a power supply. Any number of additional components, different components, and/or combinations of components can also be included in the computing device. The bus represents what may be one or more busses (such as, for example, an address bus, data bus, or combination thereof). Similarly, in embodiments, the computing device can include a number of processors, a number of memory components, a number of I/O ports, a number of I/O components, and/or a number of power supplies. Additionally any number of these components or combinations thereof can be distributed and/or duplicated across a number of computing devices.

Any number of other various types of embodiments may be contemplated within the ambit of the invention. Accordingly, the scope of the present invention is intended to embrace all such alternatives, modifications, and variations as fall within the scope of the present disclosure, together with all equivalents thereof While the subject matter of embodiments of the inventions disclosed herein is described with specificity, the description itself is not intended to limit the scope of this patent. Rather, the inventors have contemplated that the claimed subject matter might also be embodied in other ways, to include different steps or features, or combinations of steps or features similar to the ones described in this document, in conjunction with other technologies. Moreover, although the term “block” may be used herein to connote different elements of methods employed, the term should not be interpreted as implying any particular order among or between various steps herein disclosed unless and except when the order of individual steps is explicitly called for.

The following is claimed:

1. A method of using a computing device to provide a representation of at least a portion of a domain model, the method comprising:
defining a grid, using a processor, wherein defining the grid comprises defining a layout comprising a plurality of adjacent cells;
defining at least one state corresponding to at least one cell of the plurality of adjacent cells; and
defining at least one binding, wherein the at least one binding binds the at least one cell to at least one of a model entity, a model entity attribute, and a stored representation of a state of at least a portion of the domain model, and wherein the at least one binding is active based on whether the at least one state is active or inactive.

2. The method of claim 1, further comprising presenting the grid on a display device.

3. The method of claim 1, further comprising:
defining at least one additional state corresponding to the at least one cell; and
defining at least one additional binding, wherein the at least one additional binding binds the at least one cell to at least one of an additional model entity, an additional model entity attribute, and an additional stored representation of a state of at least a portion of the domain model, and wherein the at least one additional binding is active based on whether the at least one additional state is active or inactive.

4. The method of claim 1, wherein the at least one cell comprises an input element configured to receive a user input, wherein the user input changes the at least one state.

5. The method of claim 1, further comprising:
defining an additional grid, wherein the additional grid includes at least one additional cell, wherein the grid provides a first view of at least a portion of the domain model, and wherein the additional grid provides a second view of at least a portion of the domain model;
defining at least one additional state corresponding to the at least one additional cell; and
defining at least one additional binding, wherein the at least one additional binding binds the at least one additional cell to the at least one of a model entity, a model entity attribute, and a stored representation of a state of at least a portion of the domain model, wherein the at least one additional binding is active based on whether the at least one additional state is active or inactive.

6. A method of claim 1, wherein the layout comprises a collapsible representation of at least a portion of the domain model, the method comprising:
selecting a set of arbitrary dimensions of the domain model; and
defining a collapsed representation of the selected arbitrary dimensions of the domain model, wherein the collapsed representation provides a view of at least a portion of the domain model, the collapsed representation comprising a fewer number of arbitrary dimensions than the number of dimensions in the selected set of arbitrary dimensions, and wherein the view conveys information using a dimensionality based on the selected set of arbitrary dimensions.

7. The method of claim 6, wherein the set of arbitrary dimensions comprises at least one of a representation of a model entity, a representation of a model entity attribute, and a set of cells.

8. The method of claim 6, wherein each of the plurality of adjacent cells is identified by a row identifier and a column identifier; and
wherein the collapsed representation preserves the row and column identifier for each of the plurality of adjacent cells in at least one column header.

9. The method of claim 1, wherein the at least one state corresponding to the at least one cell defines a behavioral attribute, the behavioral attribute comprising at least one of an attribute that establishes the at least one cell as active or inactive, a set of allowed values, a read/write attribute that establishes the at least one cell as read only or read/write, a linkability attribute that establishes the at least one cell as linkable, validation criteria associated with the at least one cell, and a drill-down attribute that establishes whether the at least one cell provides an additional view of at least a portion of the domain model.

10. The method of claim 9, wherein the behavioral attribute comprises the linkability attribute, the method further comprising defining an allowable linkable component, wherein the allowable linkable component comprises a model entity, or a model entity attribute, and wherein a link is established if the linkable component is of a specific model entity type, or model entity attribute type.

11. The method of claim 1, wherein the domain model comprises a model entity attribute that includes at least one of a model entity state and a model entity behavior.

12. The method of claim 11, wherein the model entity state comprises at least one of a variable, a definition, a property, a method, a function, a relation, and an event.

13. The method of claim 11, wherein the model entity behavior comprises at least one of a variable, a definition, a property, a method, a function, a relation, and an event.

14. The method of claim 1, wherein the domain model comprises at least one of an analytical domain model, a time-series domain model, a financial domain model, and an engineering domain model.

15. A method of using a computing device to create a collapsible representation of at least a portion of a domain model, the method comprising:
selecting a set of arbitrary dimensions of the domain model;
defining at least one representation of the selected arbitrary dimensions of the domain model, wherein the at least one representation provides at least one first view of at least a portion of the domain model and conveys information using the number of dimensions of the selected arbitrary dimensions; and
defining, using a processor, a collapsed representation of the selected arbitrary dimensions of the domain model, wherein the collapsed representation provides at least one second view of at least a portion of the domain model, the collapsed representation comprising a fewer number of arbitrary dimensions than the number of dimensions in the selected set of arbitrary dimensions, and wherein the at least one second view conveys information using a dimensionality based on the selected set of arbitrary dimensions.

16. The method of claim 15, wherein the set of arbitrary dimensions comprises at least one of a representation of a model entity, a representation of a model entity attribute, and a set of cells.

17. The method of claim 16, wherein each cell of the set of cells is identified by a row identifier and a column identifier; and
wherein the collapsed representation preserves the row and column identifier for each cell in at least one column header.

18. The method of claim 15, further comprising presenting the collapsed representation on a display device.

19. The method of claim 15, wherein the domain model comprises at least one of an analytical domain model, a time-series domain model, a financial domain model, and an engineering domain model.
